(19) United States
(12) Patent Application Publication
(10) Pub. No.: US 2017/0270503 A1
(43) Pub. Date: Sep. 21, 2017

(54) SHOPPING SERVICE SYSTEM AND METHOD USING SMART READER, AND SMART COMMERCE METHOD USING SAME

(71) Applicants: SK TELECOM CO., LTD., Seoul (KR); JCSQUARE INC., Seoul (KR)

(72) Inventors: Song Hoon MA, Seoul (KR); Seung Hee LEE, Seoul (KR); Dae Ho JUN, Seoul (KR)

(21) Appl. No.: 15/509,051

(22) PCT Filed: Sep. 4, 2015
(86) PCT No.: PCT/KR2015/009387

§ 371 Date: Mar. 6, 2017

(30) Foreign Application Priority Data
Sep. 4, 2014 (KR) 10-2014-0117762
Sep. 4, 2014 (KR) 10-2014-0117763

(51) Int. Cl. G06Q 20/20; G06Q 30/06; G06K 7/10; G06K 17/00; G06K 19/07

(52) U.S. Cl. CPC G06Q 20/208; G06K 17/0022; G06K 19/0723; G06K 7/10297; G06K 7/10881; G06Q 30/0601; G06Q 30/0645; G06K 2017/0067

(57) ABSTRACT

A smart reader and shopping service system and method using a smart reader according to an exemplary embodiment of the present disclosure includes: a smart reader which includes an NFC tag and recognizes a product code for a product on a product display stand to obtain a product code and converts the obtained product code into product information to be recorded in the NFC tag, and transmits the recorded product information; a user terminal which includes an NFC reader, obtains the recorded product information through NFC communication between the NFC reader and the smart reader, and checks product order details for the obtained product information to request product payment and product delivery; and a shopping service providing device which manages a product code displayed on the product display stand, processes product payment requested from the user terminal, and manages delivery of the paid product.

### TECHNICAL FIELD

The present disclosure relates to a shopping service system and method using a smart reader, and a smart commerce method using the same, and more particularly, to a smart reader which performs code recognition and near field communication (NFC), a shopping service system and method using the smart reader, and a smart commerce method.

### BACKGROUND ART

Generally, a customer visits a shopping mall, selects a product to be purchased from the displayed products, directly carries it to a counter, and pays a value of the product by cash or a credit card so that a product is purchased in a shopping mall or a store. In this case, at the counter, information on products purchased by the customer is read out using a point of sale (POS) terminal equipped with a barcode reader and a price of the product is charged based on the read-out information.

Therefore, the shopping mall or store operating company needs a large display space in accordance with various products, that is, manufacturing companies, models, and quantities. A lot of manpower is needed for product management. Further, the customer moves various stores to select a product in a large shopping mall. Whenever the customer moves, the customer needs to move with the purchased products. Therefore, shopping pleasure is halved. Further, it takes a lot of time to make a payment for the product after completing the product selection.

Recently, a shopping trend is changing in accordance with rapid spread of smart phones and improvement of mobile environment. Online and mobile purchases are increasing.

A showrooming people is increasing. Further, foreign direct purchase by which products are directly purchased from the foreign countries is rapidly emerging.

Further, a distribution system in which an offline system and an online system are combined is emerging. For example, a solution which associates a fashion store with a social network is provided. According to this solution, users take pictures or videos in the offline stores. Thereafter, the users share the taken pictures or videos through social networks. Further, the users scan a barcode of the product to register the product as a product of interest. By doing this, the users share the registered product information with friends of the social networks.

In the meantime, superprecision indoor positioning services are being developed. Such superprecision indoor positioning services use a WiFi and Bluetooth low energy (BLE) technology.

The superprecision indoor positioning services provide various services such as product information, advertising video, review information, various discount benefits, and payments, based on a position measured by a customer.

While new shopping trends are increased, differentiated services of offline shopping that responds to the new shopping trends are insufficient. It is urgent to find a differentiated service for the offline shopping. Further, smart shopping which combines the shopping with internet of things (IoT) technology does not satisfy various needs of customers.

Related art is disclosed in Korean Unexamined Patent Application Publication No. 10-2002-0022261 (entitled computer network system including personal digital assistant apparatus for shopping and method of purchasing product using personal digital assistant apparatus and published on Mar. 27, 2002).

### DISCLOSURE

### Technical Problem

Exemplary embodiments of the present disclosure provide a smart reader which obtains product code information through code recognition and transmits the obtained product code information to an external device through NFC communication to enable self-shopping.

Further, in order to solve the problems in accordance with a limit of a product display space in the offline store, exemplary embodiments of the present disclosure provide a shopping service system and method using a smart reader which installs a virtual product display stand in an offline store and scans the product by a smart reader to perform product payment and product delivery, thereby improving space utilization in the limited offline store.

Further, exemplary embodiments of the present disclosure provide a shopping service system and method which manage rental and return of the smart reader in an offline store, updates product information which is changed in real time to reflect the product information in the smart reader while storing the smart reader, so that it is possible to perform self-shopping without a POS terminal or a store staff.

Further, the exemplary embodiment of the present invention provide a shopping service system and method in which a smart reader obtains a product code displayed on a product display stand on which virtual products are displayed from a product display stand on which an actual product is displayed to convert the product code into product information, and when a user terminal, a product sales terminal, a smart checkout device, and an order inquiry device check product order details for the obtained product information through NFC communication to request product payment and product delivery, more products are provided to the user in a limited store, thereby performing the product payment and product delivery.

Further, exemplary embodiments of the present disclosure provide a smart commerce method using a smart reader which maps a smart reader and a product commerce site (for example, price comparison sites or shopping mall sites) and makes a payment for a product to the mapped product commerce site when the product payment and the product delivery are requested using product order details and product commerce information (for example, price comparison information or additional product information) for the product information obtained through code recognition and NFC communication so that the product payment is processed by easily being associated with the price comparison site and the internet shopping mall through the product commerce site mapped at the time of purchasing a product using a smart reader.

### Technical Solution

According to an aspect of the present disclosure, provided is a shopping service system using a smart reader, including a smart reader which recognizes a product code for a product to obtain product code information and records the obtained product code information in an NFC tag; a shopping association device which obtains the product code information recorded in the NFC tag through NFC communication with the smart reader, checks product order details for the obtained product code information, and performs any one of inquiry, modification of order details, product payment, and product delivery for the product order details; and a shopping service providing device which manages product code information for the product, performs product payment requested from the shopping association device, and manages delivery of the paid product.

The shopping service system may further include a virtual product display stand on which a product code for a virtual product is displayed, in which the smart reader recognizes a product code displayed on the virtual product display stand.

The product association device may include a reader rental device which manages rental and return of the smart reader through membership information identification of the user.

In this case, the reader rental device may receive the product code information from the shopping service providing device to update the smart reader and include a charger to charge a smart reader which is being stored.

The shopping association device may include an NFC dongle which includes an NFC reader and obtains the recorded product information through NFC communication with the smart reader; and a smart checkout device which checks product order details for the product code information obtained through the NFC dongle and a product payment amount for the product order details to display the product order details and the product payment amount to the user, and requests the shopping service providing device to make a payment for the product corresponding to the displayed product payment amount through a payment unit of the user and deliver the product.

The shopping association device may include an NFC dongle which includes an NFC reader and obtains the recorded product information through NFC communication with the smart reader; and an order inquiry device which inquires and checks the product order details for the product code information obtained through the NFC dongle and modifies the product for the product order details.

The shopping association device may include an NFC dongle which includes an NFC reader and obtains the recorded product information through NFC communication with the smart reader; and a product sales terminal which checks the product order details for the product information obtained through the NFC dongle and a product payment amount for the product order details to display the product order details and the product payment amount to a store staff and requests the shopping service providing device to make a payment for a product corresponding to the displayed product payment amount through the payment unit of the user and deliver the product.

According to another aspect of the present disclosure, there is provided a shopping service method using a smart reader including obtaining product code information by recognizing a product code for a product, by a smart reader; recording the obtained product code information in an NFC code, by the smart reader; obtaining the product code information recorded in the NFC tag through NFC communication with the smart reader, by a shopping association device; checking product order details for the obtained product code information and performing any one of inquiry, modification of order details, product payment, and product delivery for the product order details, by the shopping association device; performing product payment requested from the shopping association device, by a shopping service providing device; and managing delivery of the paid product, by the shopping service providing device.

According to still another aspect of the present disclosure, there is provided a smart commerce method using a smart reader including mapping a commerce site for product purchase to a smart reader equipped with an NFC tag, by a commerce service device; obtaining a product code by recognizing the product code for a product and recording the product information in the NFC tag by converting the obtained product code into product information, by the smart reader; obtaining the recorded product information through NFC communication with the smart reader, by a shopping association device; requesting product payment through the mapped commerce site, by the commerce service device, when there is product purchase request of a user from the shopping association device; and making a payment for the product requested through the mapped commerce site, by the payment service device.

### Advantageous Effects

According to the exemplary embodiment of the present disclosure, product code information is obtained by recognizing a code and the obtained product code information is transmitted to an external device through NFC communication to enable self-shopping.

According to an exemplary embodiment of the present disclosure, in order to solve the problem due to a limited product display space in an offline store, a virtual product display stand is provided in an offline store and scanned by a smart reader to perform product payment and product delivery, to improve space utilization in the limited offline store.

According to the exemplary embodiment of the present disclosure, rental or return of the smart reader is managed in the offline store and product information which is changing in real time while storing the smart reader is updated to be reflected to the smart reader, thereby providing a shopping service which enables the self-shopping without providing a POS terminal or a store staff.

According to the exemplary embodiment of the present disclosure, the smart reader obtains a product code displayed on a product display stand to convert the product code into product information and when a user terminal, a product sales terminal, a smart checkout device, and an order inquiry device check product order details for the obtained product information through NFC communication to request product payment and product delivery, more products are provided to a user in a limited store to perform product payment and product delivery.

According to the exemplary embodiment of the present disclosure, it is possible to map a smart reader and a product commerce site (for example, price comparison sites or shopping mall sites) and make a payment for a product to the mapped product commerce site when the product payment and the product delivery are requested using product details and product commerce information (for example, price comparison information or additional product information) for the product information obtained through code recognition and NFC communication so that the product payment is processed by easily being associated to the price comparison site and the internet shopping mall through the product commerce site mapped at the time of purchasing a product using a smart reader.

### DESCRIPTION OF DRAWINGS

FIG. 1 is a diagram of a shopping service system using a smart reader according to an exemplary embodiment of the present disclosure.

FIG. 2 is a diagram of a smart reader according to an exemplary embodiment of the present disclosure.

FIG. 3 is a flowchart of a code recognition and NFC communication method in a smart reader according to an exemplary embodiment of the present disclosure.

FIG. 4 is a flowchart of a reader management method in a reader management device according to an exemplary embodiment of the present disclosure.

FIG. 5 is a flowchart of a shopping service method using a smart reader according to an exemplary embodiment of the present disclosure.

FIG. 6 is a flowchart of a shopping service method which is linked to a product sales terminal according to an exemplary embodiment of the present disclosure.

FIG. 7 is a flowchart of a shopping service method which is linked to a smart checkout device according to an exemplary embodiment of the present disclosure.

FIG. 8 is a flowchart of a shopping service method which is linked to an order inquiry device according to an exemplary embodiment of the present disclosure.

FIG. 9 is a flowchart of a shopping service method which is linked to a product display stand according to an exemplary embodiment of the present disclosure.

FIG. 10 is a view illustrating an implement example of a shopping service system using a smart reader according to an exemplary embodiment of the present disclosure.

FIG. 11 is a flowchart of a smart commerce method which is mapped to a payment unit according to an exemplary embodiment of the present disclosure.

FIG. 12 is a flowchart of a smart commerce method which is mapped to a price comparison site according to an exemplary embodiment of the present disclosure.

FIG. 13 is a flowchart of a smart commerce method which is mapped to a shopping mall site according to an exemplary embodiment of the present disclosure.

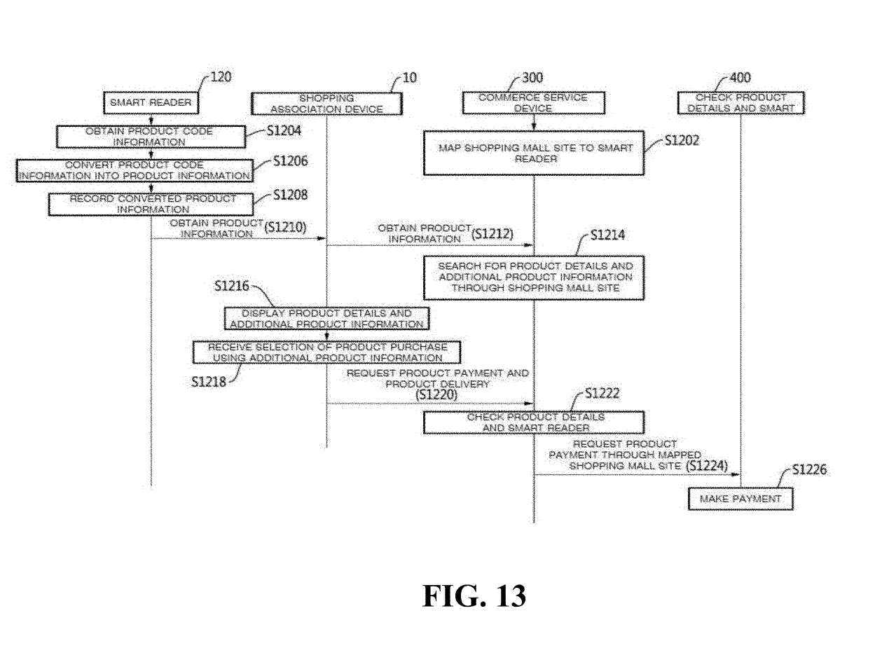

### BEST MODE

Hereinafter, exemplary embodiments of the present disclosure will be described in detail with reference to the accompanying drawings.

When the exemplary embodiments are described, a technology which is well known in the technical field of the present disclosure and is not directly related with the present disclosure will not be described. The reason is that unnecessary description is omitted to clearly transmit the gist of the present invention without obscuring the gist. By the same reason, in the accompanying drawings, some parts are exaggerated, omitted, or schematically illustrated. Further, an actual size is not fully reflected to the size of each component. In the drawings, like reference numerals denote like or corresponding components.

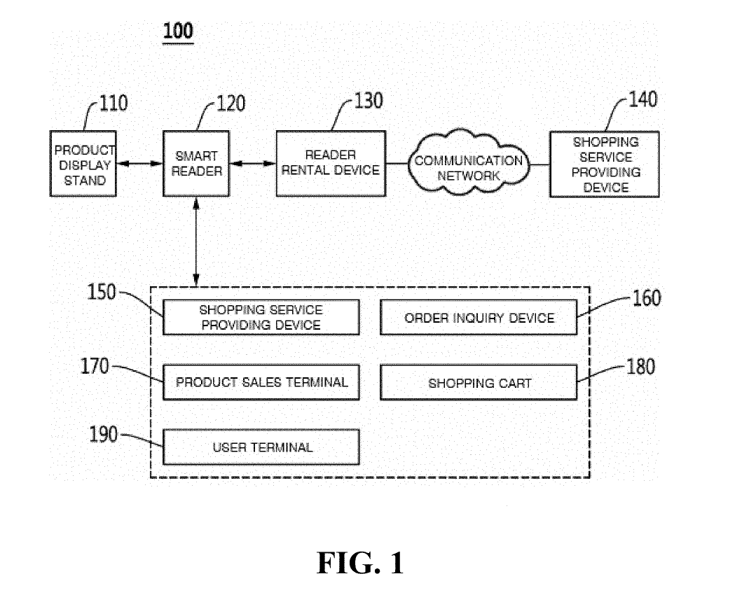

FIG. 1 is a diagram of a shopping service system using a smart reader according to an exemplary embodiment of the present disclosure.

Referring to FIG. 1, a shopping service system 100 using a smart reader 120 according to an exemplary embodiment of the present disclosure includes a product display stand 110, a smart reader 120, a reader rental device 130, a shopping service providing device 140, and a shopping association device 10.

The shopping association device 10 is associated with the smart reader 120 to process order details, product payment, and product delivery of a product ordered by the smart reader. To this end, the product association device 10 includes a smart checkout device 140, an order inquiry device 150, a product sales terminal 160, a shopping cart 170, and a user terminal 170.

The shopping service providing device 140 may include a product management unit 141, a payment unit 142, a delivery management unit 143 and a storage unit 144.

Hereinafter, specific configurations and operations of respective components of the shopping service system 100 using the smart reader 120 according to the exemplary embodiment of the present disclosure will be described.

The smart reader 120 includes an NFC tag.

The smart reader 120 recognizes a product code for a product of the product display stand 110 to obtain product code information. Here, the smart reader 120 may recognize the product code for a virtual product which is displayed on a virtual product display stand. The product code may include at least one of one-dimensional, two-dimensional, and three-dimensional barcode information. The one-dimensional barcode information refers to barcode information in form of a code in which black and white bar symbols having different thicknesses are combined. The two-dimensional barcode information refers to barcode information in form of a code in which black and white square symbols are arranged in a mosaic manner. The two-dimensional barcode includes a quick response code (QR code), data matrix, and maxi code. The three-dimensional code information refers to various types of barcode information rather than planar code type barcode information and may contain more information than the one-dimensional and two-dimensional barcode information. The three-dimensional barcode may be a color code. The smart reader 120 converts the obtained product code into product information and records the product information in the NFC tag. Here, the product information includes any one or more of product information including advertisement of a corresponding brand, a manufacturer, a seller, a releasing time, an expiration date, price information, a serial number, a product name, and contact information.

The smart reader 120 is basically associated with the reader rental device 130 to be stored and charged in an offline store and may be rented or returned by a general user (customer). Further, the smart reader 120 transmits code information of an ordered product to any one of the smart checkout device 150, the order inquiry device 160, the product sales terminal 170, the shopping cart 170, and the user terminal 190 through NFC communication.

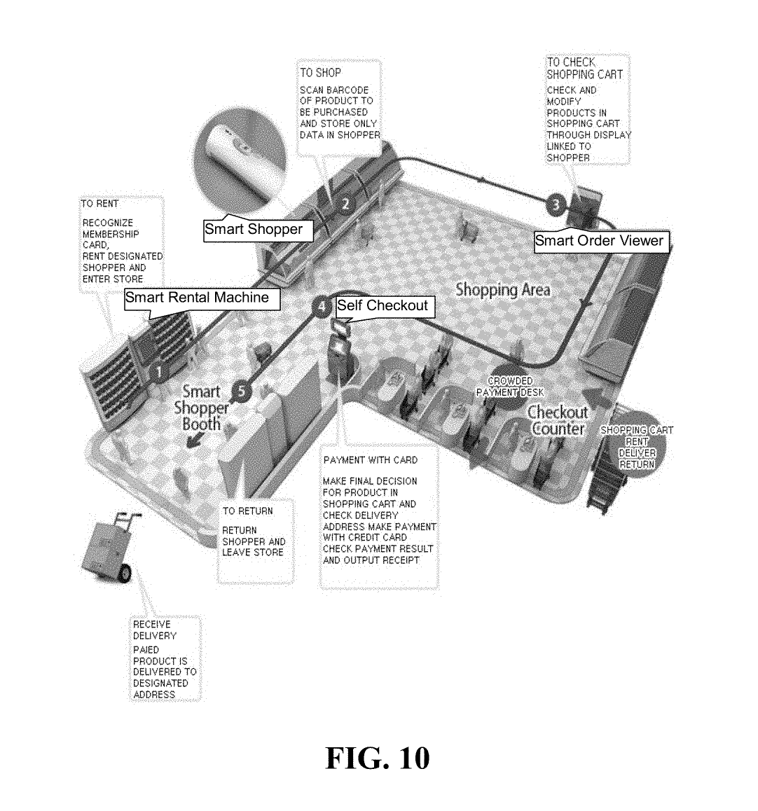

For example, the smart checkout device 150, as illustrated in FIG. 10, means a self-checkout counter 4 in an offline store and performs payment on the order details of the products ordered through the smart reader. The order inquiry devices 160 correspond to terminals (3: smart order viewers) provided in various places in the offline store to check and modify order details of the products ordered through the smart reader before making a payment for the products.

This will be described in detail below.

In the exemplary embodiment, the smart reader 120 is stored or installed in the offline store and provided through user information confirmation when the smart reader is necessary for the user.

The shopping service providing device 140 manages product code information on the product displayed on the product display stand 110 and product information on a discounted product, an event product, and no delivery product. Further, the shopping service providing device 140 manages information on a user who rents and returns through the smart reader 120 and product order details corresponding to the user information.

Further, the shopping service providing device 140 performs the product payment requested from the product association device 10 and manages the delivery of the payment processed product.

The reader rental device 130 receives product information from the shopping service providing device 140 to update the product information in the smart reader 120 which is stored.

Further, the reader rental device 130 includes a charger to charge the smart reader 120 which is being stored and manages the rental and return of the smart reader through the user information identification. Here, the user information may include membership card information, mobile membership information, and user terminal information. In the case of the membership card information, identification of the user information may be performed by recognizing a membership card which is issued to each user and confirming whether the recognized membership card information coincides with user information. In the case of the mobile membership information, identification of the user information may be performed by scanning mobile information presented through the user terminal or directly inputting the information. Further, the reader rental device 130 identifies the user information through NFC communication.

The smart checkout device 150 is connected to an NFC dongle equipped with an NFC reader. Here, the smart checkout device 150 may include an NFC dongle equipped with an NFC reader.

The smart checkout device 150 checks the product order details on the product code information obtained through the NFC dongle and a product payment amount for the product order details to display the product order details and the product payment amount to the user. The smart checkout device 150 requests the shopping service providing device 140 to make a payment for the product corresponding to the product payment amount through the payment unit of the user and deliver the product.

The order inquiry device 160 is connected to the NFC dongle equipped with the NFC reader. Here, the order inquiry device 160 may include an NFC dongle equipped with an NFC reader.

The order inquiry device 160 checks the product order details for the product code information obtained through the NFC dongle and a product payment amount for the product order details to display the product order details and the product payment amount to the user. The order inquiry device 160 may modify the product order details and the product payment amount for the product order details in accordance with a product modifying request of the user.

The product sales terminal 170 performs NFC communication with the smart reader 120 through the NFC dongle to obtain the recorded product information. The product sales terminal 170 checks the product order details for the product information obtained through the NFC dongle and the product payment amount for the product order details to display the product order details and the product payment amount to a store staff. Next, the product sales terminal 170 requests the shopping service providing device 140 to make a payment for the product corresponding to the product payment amount through the payment unit of the user and deliver the product.

The shopping cart 180 fixes the user terminal 190 and is connected to the user terminal 190 to transmit and receive data. When the smart reader 120 converts the product code into product information to record the product information in the NFC tag, the user terminal 190 fixed to the shopping cart 180 obtains the recorded product information. The user terminal 190 checks the product order details for the product information obtained through the shopping cart 180 to request product payment and product delivery.

The user terminal 190 includes an NFC reader. The user terminal 190 obtains product code information through NFC communication between the NFC reader and the smart reader 120. The user terminal 190 checks the order details for the obtained product code information to request the product payment and the product delivery.

With regard to this, the user terminal 190 includes a shopping application to provide shopping convenience to the user. A mobile card which is not an actual object may be installed in the user terminal 190. The user terminal 190 stores mobile coupons in the shopping application so as to use mobile coupons instead of paper coupons.

The user terminal 190 recognizes a product code of the product display stand 110 and makes a payment and delivers the product therethrough. In contrast, the user terminal 190 may purchase a product through a shopping function using price comparison such as specific product search, popular product search, related product search using price comparison for every product code.

In the meantime, the product display stand 110 displays the product code for the product. Here, the product display stand 110 may include an NFC reader. As another example, the product display stand 110 may be a virtual product display stand which is provided in a store or a house and may be a leaflet or a label on which a product code for a virtual product is printed.

The product display stand 110 may display an image of the virtual product display stand including virtual product shelves together with the product code. An image of the product display stand includes an image of at least one product shelf. Here, the image of the virtual product display stand may have the same size as a stand in the associated offline store or correspond to a reduced or enlarged image within a predetermined range. Further, the image of the virtual product display stand may be configured by a photo or an image of the product store of the offline store.

The product display stand 110 may provide an image of at least one virtual product displayed in the virtual product shelves together with the product code. Here, the image of the virtual product corresponds to an image (an actual image) of the actual product, but is not limited thereto and includes various types of images which distinguish the product. Further, the product image may have the same size as the product in the associated offline store or correspond to a reduced or enlarged image within a predetermined range.

The product display stand 110 may provide the product code and the product image arranged based on at least one of a user age range, a sales area, a selling time zone, a theme, or blocking.

The product display stand 110 may provide the product codes for the displayed virtual products below the product image. That is, the product code may be disposed below the image of the corresponding product. The product display stand 110 may also display the product code at an upper side, left side, or right side of the product image. Here, the product code is a code which is optically recognized and may include a bar code or a quick response (QR) code. Further, the product display stand 110 is printed or output using an infra-red ink which is not visible to the human eye but is recognized only by an optical scanner of the user terminal 190 or a paint having the same function to create a natural store and product displaying atmosphere.

The product display stand 110 may be implemented in a physical space of the store or the house. The product display stand may be implemented by being output to a display unit such as a poster or a leaflet using a paper, a printed paper, a photo paper, a vinyl, a plastic sheet, a cloth, or a label paper in an idle space such as a wall or a door of a store or a house.

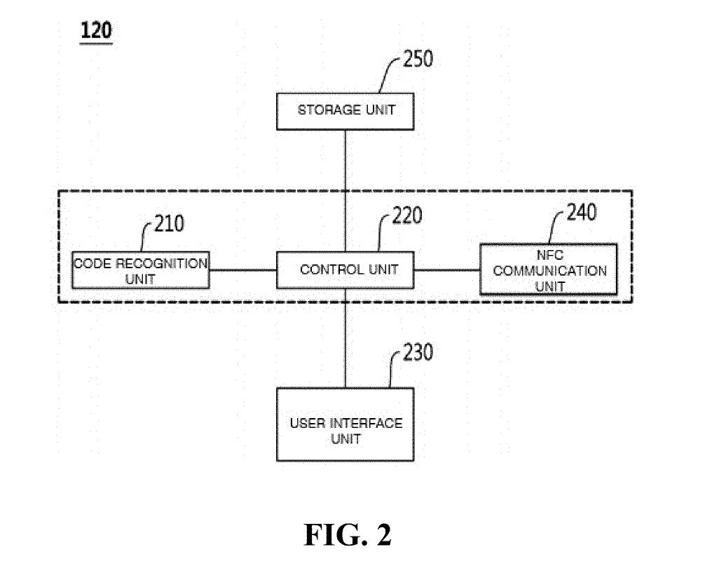

FIG. 2 is a diagram of a smart reader 120 according to an exemplary embodiment of the present disclosure.

Referring to FIG. 2, the smart reader 120 according to the exemplary embodiment of the present disclosure basically includes a code recognition unit 210, a control unit 220, and an NFC communication unit 240. If necessary, the smart reader 120 may include a user interface unit 230 and a storage unit 250.

When the smart reader 120 is simply configured by the code recognition unit 210, the control unit 220, and the NFC communication unit 240, the smart reader 120 recognizes the product code of the product display stand 110 by the code recognition unit 210 to obtain product code information and transmits the obtained product code information to the product association device through the NFC communication unit 240.

Specifically, the code recognition unit 210 recognizes the product code for the product to obtain product code information. The code recognition unit 210 may recognize the product code for a virtual product which is displayed on a virtual product display stand. Here, the virtual product display stand may be implemented in a physical space of a store or a house. The virtual product display stand may be implemented by being output to a display unit such as a poster or a leaflet using a paper, a printed paper, a photo paper, a vinyl, a plastic sheet, a cloth, or a label paper in an idle space such as a wall or a door of a store or a house.

The virtual product display stand may be implemented by a screen of at least one display such as an LCD or an LED. The virtual product display stand may change the product code and the product image for the virtual product in accordance with the displaying of the virtual products in real time to display the product code and the product image.

The user interface unit 230 may output the product code obtained by the code recognition unit 210 to the user. Further, the user interface unit 230 may receive the user input in relation to the output product code.

The control unit 220 converts the product code obtained by the code recognition unit 210 into product information using product information for every product code stored in the storage unit 250.

The NFC communication unit 240 includes a near field communication (NFC) tag. The NFC communication unit 240 records the converted product information in the NFC tag. The NFC communication unit 240 communicates with the shopping association device 10 through the NFC communication and transmits the recorded product information to the shopping association device 10. Here, the NFC communication unit 240 may communicate with any one shopping association device 10 of the user terminal 190 equipped with an NFC reader, the reader management device 150, the product sales terminal 160, the smart checkout device 150, the order inquiry device 160, and the product display stand 110 through the NFC communication. The storage unit 250 stores product information for every product code. The storage unit 250 may store the product code obtained by the code recognition unit 210 and the converted product information.

Further, the storage unit 250 may previously store additional product information (for example, coupon information, product discount information, and store event information) related to the product code obtained by the code recognition unit 210. The control unit 220 may convert the product code obtained by the code recognition unit 210 and the additional product information related to the obtained product code to be included in the product information. The control unit 220 records the product information including the additional product information in the NFC tag.

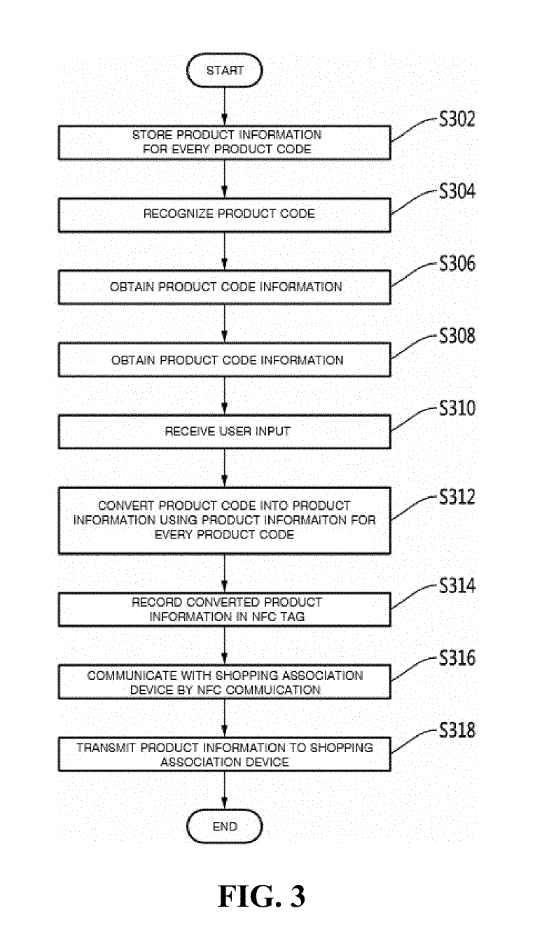

FIG. 3 is a flowchart of a code recognition and NFC communication method in a smart reader according to an exemplary embodiment of the present disclosure. The storage unit 250 stores product information for every product code (S302).

The code recognition unit 210 recognizes product code for a product (S304). Here, the code recognition unit 210 may recognize the product code for a virtual product which is displayed on a virtual product display stand.

The code recognition unit 210 obtains product code information through the code recognition (S306).

The user interface unit 230 outputs the obtained product code information to the user (S308).

The user interface unit 230 receives a user input related to the output product code information (S310).

The control unit 220 converts the product code into product information using product information for every product code stored in the storage unit 250 (S312). Here, when the additional product information related to the obtained product code is stored in advance in the storage unit 250, the control unit 220 may convert the obtained product code and the additional product information related to the obtained product code to be included in the product information.

The NFC communication unit 240 records the product information converted by the control unit 220 in the equipped NFC tag (S314). Here, the control unit 220 may record the product information including the additional product information in the NFC tag.

The NFC communication unit 240 communicates with the shopping association device 10 through the NFC communication (S316).

The NFC communication unit 240 transmits the recorded product information to the shopping association device 10 through the NFC communication (S318).

As described above, it is described that the smart reader 120 converts the product code into product information for every product code and transmits the product information, but the present invention is not limited thereto. The smart reader may transmit product code information obtained by the code recognition as it is without converting the product code information into the product information.

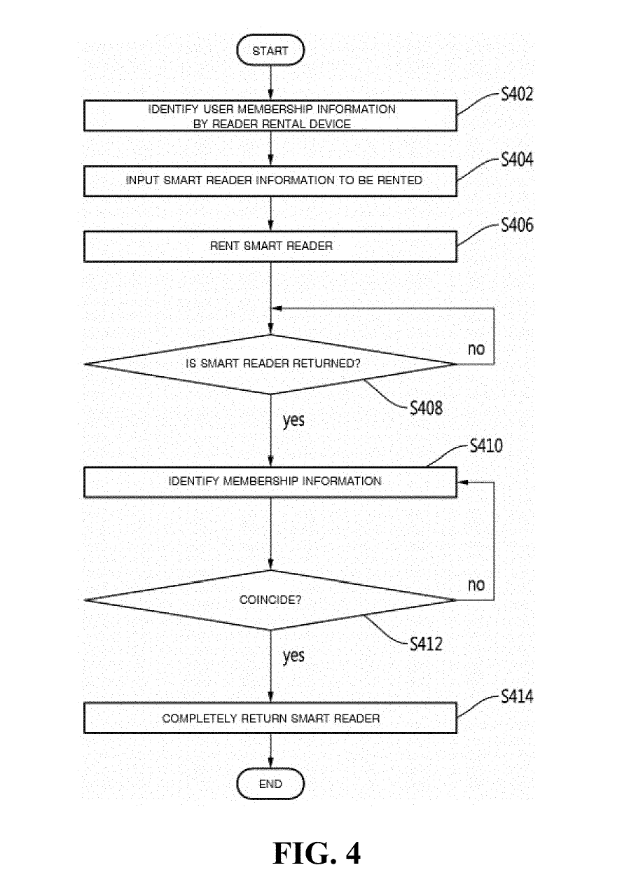

FIG. 4 is a flowchart of a smart reader management method in a reader rental device according to an exemplary embodiment of the present disclosure.

First, the reader rental device receives product code information on a product which is changed in real time, such as a discounted product, an event product, a no-delivery product, from the shopping service providing device 140 and updates the information in the stored smart reader.

The reader rental device charges the smart reader which is stored.

Therefore, when the user requests the rental of the smart reader, the reader rental device identifies the membership information of the user (S402). As the identification method, a membership card or a mobile membership card issued for every user is scanned to identify the user information. Alternatively, terminal information (phone number) of the user is input and checks whether to coincide with the terminal information.

Thereafter, the reader rental device inputs information of a smart reader to be rented (S404).

Thereafter, the reader rental device processes rental of a smart reader (S406).

Thereafter, when there is a return request from the user, the reader rental device checks whether to coincide with the membership information of the user (steps S418 and S410).

When the user information coincides with the mapped membership information of the user (S412), the reader rental device accepts the return of the smart reader 120 which coincides with the mapped user information (S414). In contrast, when the user information does not coincide with the mapped membership information of the user, the reader rental device does not accept the return of the smart reader and performs step S410 again.

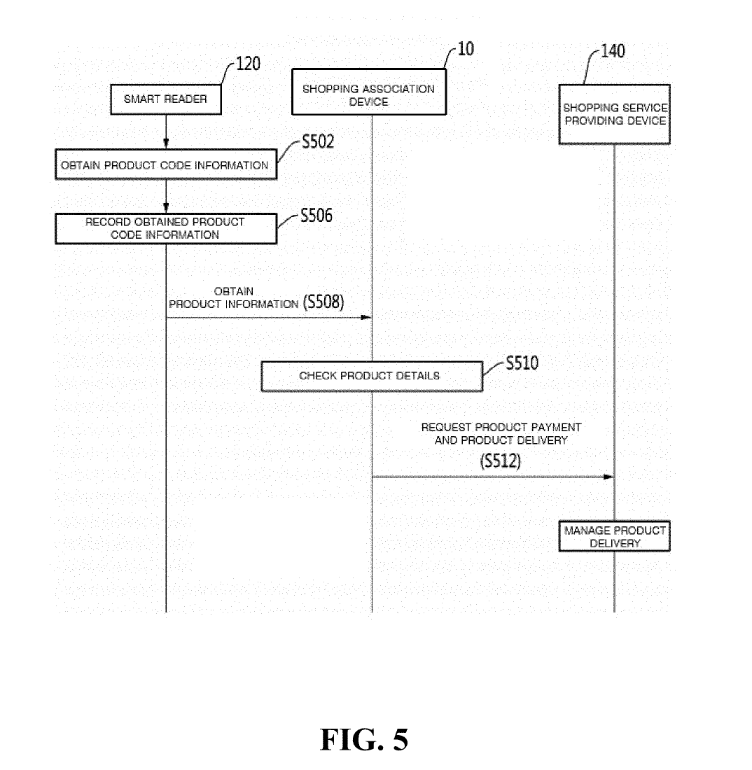

FIG. 5 is a flowchart of a shopping service method using a smart reader according to an exemplary embodiment of the present disclosure.

The smart reader 120 recognizes a product code for a product of the product display stand 110 to obtain product code information (S502).

Thereafter, the smart reader 120 records the obtained product information in the NFC tag (S506).

In the meantime, the shopping association device 10 obtains the recorded product code information through the NFC communication with the smart reader 120 (S508). Here, the shopping association device 10 may include at least one of the user terminal 190, the reader management device 150, the product sales terminal 160, the smart checkout device 150, the order inquiry device 160, and the shopping cart 180.

Further, the shopping association device 10 checks the product order details for the obtained product code information (S510).

Next, the shopping association device 10 requests the product payment and product delivery (S512).

The shopping service providing device 140 performs the product payment requested from the shopping association device 10 (S514).

The shopping service providing device 140 manages the delivery of the paid product (S516).

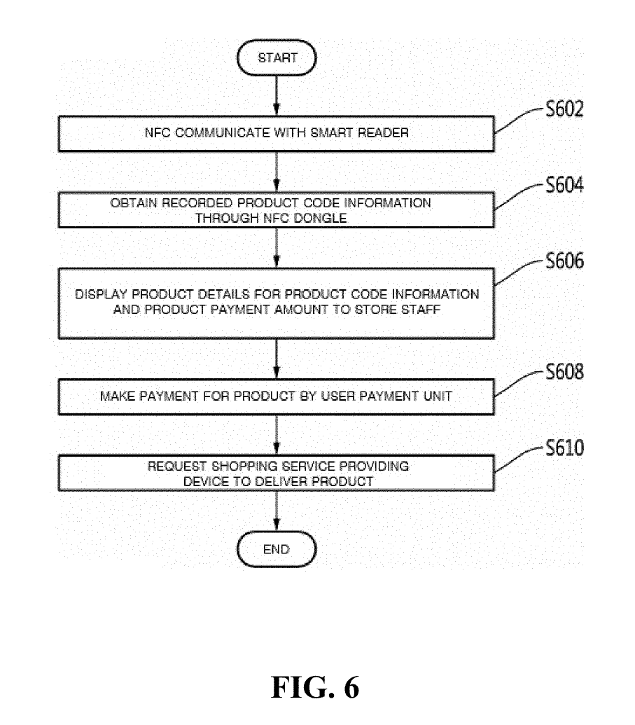

FIG. 6 is a flowchart of a shopping service method which is linked to a product sales terminal according to an exemplary embodiment of the present disclosure.

The product sales terminal 160 performs NFC communication with the smart reader 120 (S602).

The product sales terminal 160 obtains the product information recorded in the NFC tag through the NFC communication, through the NFC dongle (S604).

Next, the product sales terminal 160 checks the product order details for the product information obtained by the NFC dongle and the product payment amount for the product order details to display the product order details and the product payment amount to the store staff (S606).

The product sales terminal 160 requests the shopping service providing device 140 to make a payment for the product corresponding to the product payment amount displayed through the payment unit of the user and deliver the product (S608).

The product sales terminal 160 requests the shopping service providing device 140 to deliver the product for the product order details for which a payment has been completed through the payment unit of the user (S610).

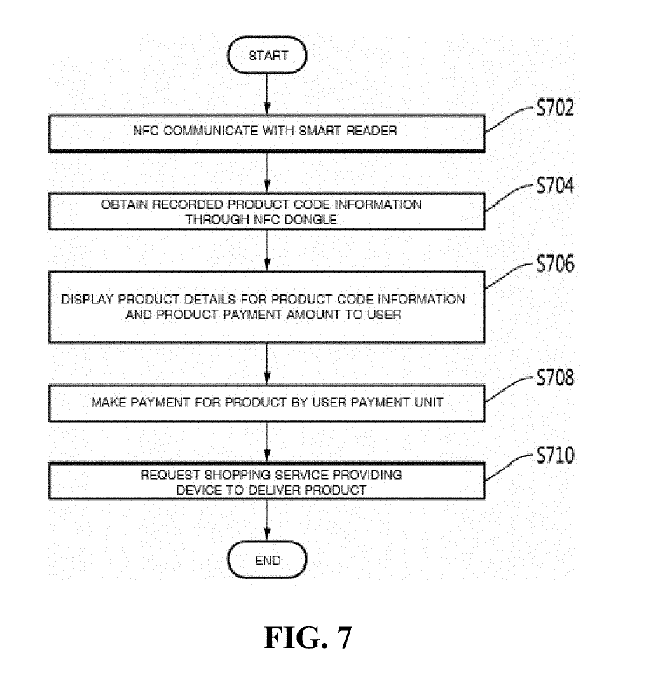

FIG. 7 is a flowchart of a shopping service method which is linked to a smart checkout device according to an exemplary embodiment of the present disclosure.

The smart checkout device 150 performs NFC communication with the smart reader 120 (S702).

The smart checkout device 150 obtains the product information recorded in the NFC tag through the NFC communication, through the NFC dongle (S704).

Next, the smart checkout device 150 checks the product order details for the product information obtained by the NFC dongle and the product payment amount for the product order details to display the product order details and the product payment amount to the store staff (S706).

The smart checkout device 150 requests the shopping service providing device 140 to make a payment for the product corresponding to the product payment amount displayed through the payment unit of the user and deliver the product (S708).

The smart checkout device 150 requests the shopping service providing device 140 to deliver the product for the product order details for which a payment has been completed through the payment unit of the user (S710).

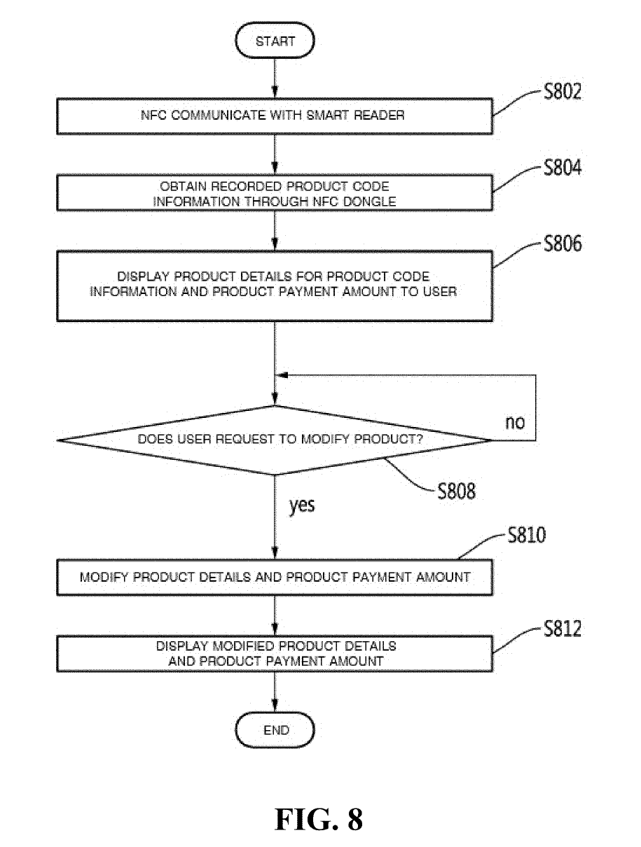

FIG. 8 is a flowchart of a shopping service method which is linked to an order inquiry device according to an exemplary embodiment of the present disclosure.

The order inquiry device 160 performs NFC communication with the smart reader 120 (S802).

The order inquiry device 160 obtains the product information recorded in the NFC tag through the NFC communication, through the NFC dongle (S804).

Next, the order inquiry device 160 checks the product order details for the product information obtained through the NFC dongle and the product payment amount for the product order details to display the product order details and the product payment amount to the user (S806).

The order inquiry device 160 checks whether the user requests to modify the product (S808).

As a checking result, when the user requests to modify the product, the order inquiry device 160 modifies the product order details and a product payment amount for the product order details in accordance with the request for modification of the product by the user (S810).

Next, the order inquiry device 160 displays the modified product order details and the product payment amount for the product order details to the user (S812).

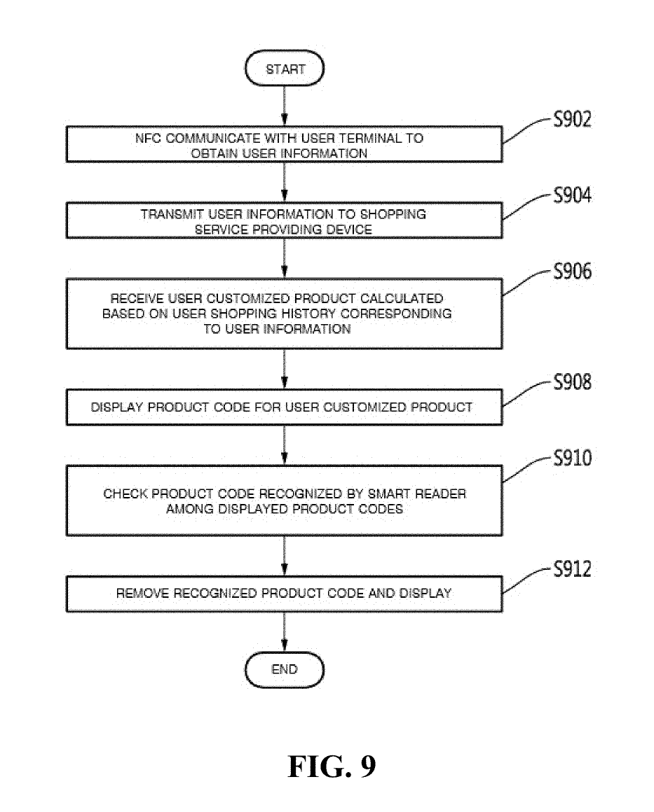

FIG. 9 is a flowchart of a shopping service method which is linked to a product display stand according to an exemplary embodiment of the present disclosure.

The product display stand 110 obtains user information through the NFC communication with the user terminal 190 (S902).

The product display stand 110 transmits the user information obtained through the NFC communication to the shopping service providing device 140 (S904).

Then, the shopping service providing device 140 calculates customized product information based on a user shopping history corresponding to the user information. Next, the product display stand 110 receives the customized product information calculated in the shopping service providing device 140 based on the user shopping history corresponding to the user information (S906).

The product display stand 110 displays the product code for the customized product information received from the shopping service providing device 140 (S908).

The shopping display stand 110 checks a product code recognized by the smart reader 120 among product codes displayed by being associated with the shopping service providing device 140 (S910).

The product display stand 110 removes a product code recognized by the smart reader 120 from the displayed product code to display the remaining product codes or additional product codes (S912).

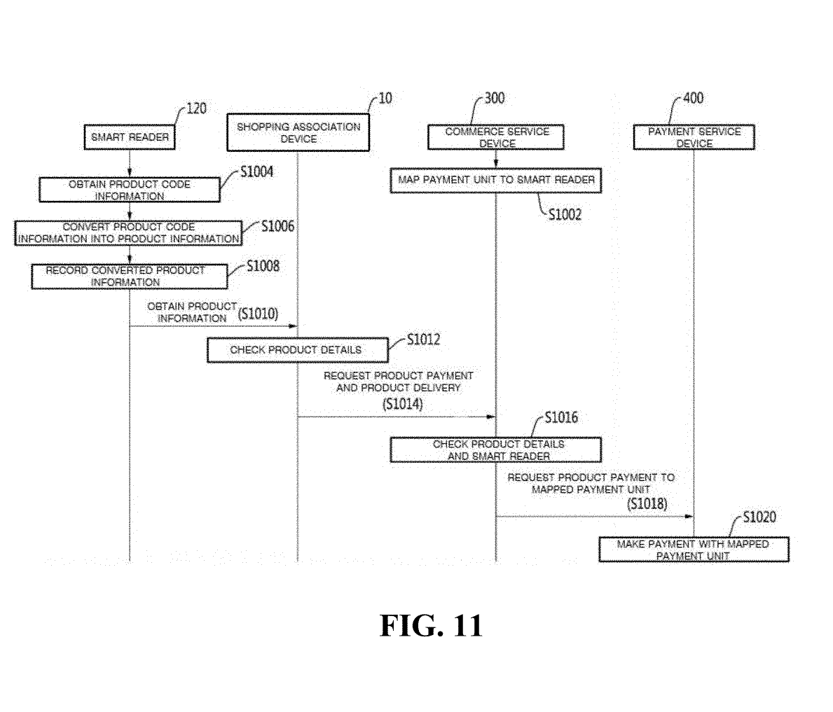

FIG. 11 is a flowchart of a smart commerce method using a smart reader according to an exemplary embodiment of the present disclosure.

First, the smart reader 120 recognizes the product code for the product to obtain product code information (S1004). Here, the smart reader 120 may recognize the product code for a virtual product which is displayed on a virtual product display stand 110.

Thereafter, the smart reader 120 converts the obtained product code into product information (S1006).

Next, the smart reader 120 records the converted product information in the NFC tag (S1008).

In the meantime, the shopping association device 10 obtains the recorded product information through the NFC communication with the smart reader 120 (S1010). Here, the shopping association device 10 may include at least one of the user terminal 190, the reader management device 140, the product sales terminal 150, the smart checkout device 160, and the shopping cart 170.

Further, the shopping association device 10 checks the product order details for the obtained product code information (S1012). The product order details may include a product name of the product, a product price, brief description of the product, and product evaluation.

Next, the shopping association device 10 requests the product payment and product delivery (S1014).

Further, the commerce service device 300 identifies the smart reader 120 before requesting the product payment and checks a payment unit mapped to the identified smart reader 120 in step S1002 (S1016).

Next, the commerce service device 300 requests the payment service device 400 to make a payment for the product by the mapped payment unit (S1018).

The payment service device 400 makes a payment for the product using the mapped payment unit in accordance with the payment request of the commerce service device 300 (S1020).

FIG. 11 is a flowchart of a smart commerce method using a smart reader according to an exemplary embodiment of the present disclosure.

The smart commerce device 141 maps the price comparison site to the smart reader 120 (S1102). Here, the price comparison site provides the price comparison information of the prices of the product according priorities (for example, popularities, prices, releasing date, a rating order, or a purchase rank) posted on an offline or online shopping mall site. The price comparison site and the smart reader 120 are previously mapped to each other before purchasing the product using the smart reader 120. By doing this, the user may purchase a product with a discounted price through the mapped price comparison site or purchase a product through an additional service such as a promotion.

Further, the smart reader 120 recognizes the product code for the product to obtain the product code (S1104). Here, the smart reader 120 may recognize the product code for a virtual product which is displayed on the product display stand 110 or a virtual product display stand.

Then, the smart reader 120 converts the obtained product code into product information (S1106).

Next, the smart reader 120 records the converted product information in the NFC tag (S1108).

In the meantime, the shopping association device 10 obtains the recorded product information through the NFC communication with the smart reader 120 (S1110). Here, the shopping association device 10 may include at least one of the user terminal 190, the reader management device 150, the product sales terminal 160, the smart checkout device 150, and the shopping cart 170.

The commerce service device 300 obtains the product order details for the product obtained in the shopping association device 10 from the shopping association device 10 (S1112).

The commerce service device 300 searches for the product order details and price comparison information corresponding to product commerce information through the price comparison site (S1114). The price comparison information refers to information obtained by comparing prices of a product which is associated with the online or offline shopping mall site related to the product. The price comparison information may be information obtained by classifying the prices of the product for every online shopping purchase site to compare the prices. Here, the commerce service device 300 checks whether there is additional product information which is set by a user through the smart reader 120 to automatically purchase the product in accordance with a product purchasing cycle.

The commerce service device 300 may add additional product information to the product information according to the product purchase cycle. In this case, the commerce service device 300 may search for the product order details and the product commerce information for the product information to which the additional product information is added through the mapped commerce site.

When the commerce service device 300 transmits the searched product order details and price comparison information corresponding to the product commerce information to the shopping association device 10, the shopping association device 10 displays the searched product order details and price comparison information corresponding to the product commerce information to the user (S1116).

The commerce service device 300 accepts selection of product purchase for the product order details desired by the user, among the displayed price comparison information (S1118).

Next, the shopping association device 10 requests the product payment and product delivery for the product order details which is selected to be purchased by the user (S1120).

Further, the commerce service device 300 identifies the smart reader 120 before requesting the product payment and checks the price comparison site mapped to the identified smart reader 120 in step S1102 and also checks the product order details which are selected to be purchased by the user (S1122).

Next, the commerce service device 300 requests the payment service device 400 to make a payment for the product through the mapped price comparison site (S1124). Here, the commerce service device 300 may request another shopping site which is linked to price comparison information of the price comparison site to make a payment for the product.

The payment service device 400 makes a payment for the product through the mapped price comparison site in accordance with the payment request of the commerce service device 300 (S1126).

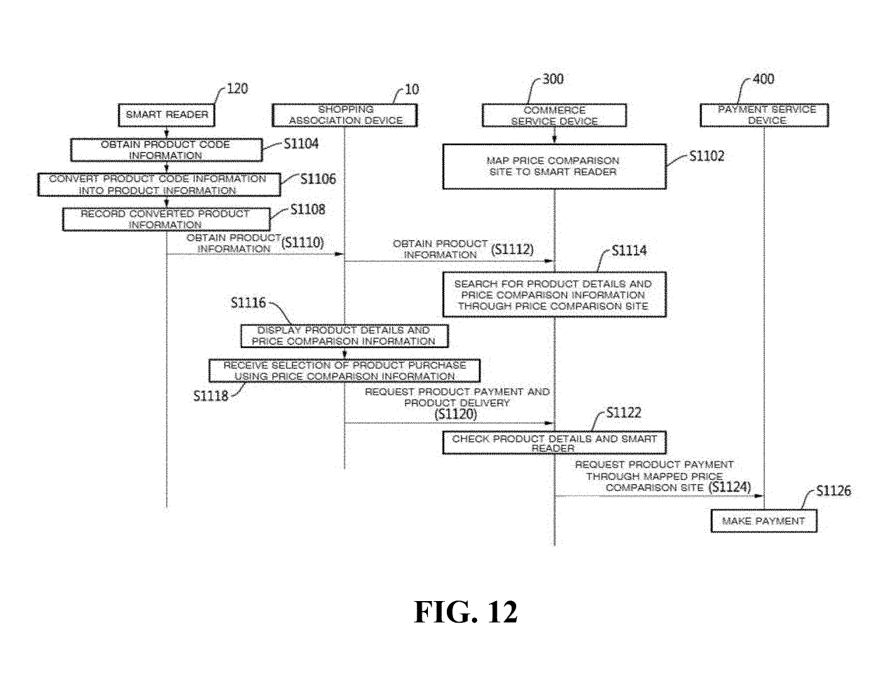

FIG. 12 is a flowchart of a smart commerce method using a smart reader according to an exemplary embodiment of the present disclosure.

The smart commerce device 141 maps the price comparison site to the smart reader 120 (S1202). Here, the shopping site provides the prices of the product in accordance with the priorities posted on the offline or online shopping mall site. The shopping mall site and the smart reader 120 are previously mapped to each other before purchasing the product using the smart reader 120. By doing this, the user may purchase a product with a discounted price through the mapped shopping mall site or purchase a product through an additional service such as a promotion.

Further, the smart reader 120 recognizes the product code for the product to obtain the product code (S1204). Here, the smart reader 120 may recognize the product code for a virtual product which is displayed on the product display stand 110 or a virtual product display stand.

Then, the smart reader 120 converts the obtained product code into product information (S1106).

Next, the smart reader 120 records the converted product information in the NFC tag (S1208).

In the meantime, the shopping association device 10 obtains the recorded product information through the NFC communication with the smart reader 120 (S1210). Here, the shopping association device 10 may include at least one of the user terminal 190, the reader management device 150, the product sales terminal 160, the smart checkout device 150, and the shopping cart 170.

The commerce service device 300 obtains the product order details for the product obtained in the shopping association device 10 from the shopping association device 10 (S1212).

The commerce service device 300 searches for the product order details and additional product information corresponding to product commerce information through the shopping mall site (S1214). Here, the additional product information may refer to promotion information such as event information, discount coupon, free coupon, or video or access information which allows access to a medium in which promotion information is stored.

When the commerce service device 300 transmits the searched product order details and additional product information corresponding to the product commerce information to the shopping association device 10, the shopping association device 10 displays the searched product order details and additional product information corresponding to the product commerce information to the user (S1216).

The commerce service device 300 accepts selection of product purchase for the product order details desired by the user, among the displayed additional product information (S1218).

Next, the shopping association device 10 requests the product payment and product delivery for the product order details which is selected to be purchased by the user (S1220).

Further, the commerce service device 300 identifies the smart reader 120 before requesting the product payment and checks the shopping mall site mapped to the identified smart reader 120 in step S1102 and also checks the product order details which is selected to be purchased by the user (S1222).

Next, the commerce service device 300 requests the payment service device 400 to make a payment for the product through the mapped shopping mall site (S1224).

Here, the commerce service device 300 may request another shopping site which is linked to the additional product information of the shopping mall site to make a payment for the product.

The payment service device 400 makes a payment for the product through the mapped shopping mall site in accordance with the payment request of the commerce service device 300 (S1226).

In the meantime, when the price comparison information or the additional product information for an original product is not searched, the commerce service device 300 searches related product information related to the product information from an equipped product information DB and researches the price comparison information or the additional product information using the searched related product information. For example, the commerce service device 300 divides the product name included in the product information in the unit of words to generate a plurality of divided product names and researches the price comparison information or the additional product information using the plurality of generated divided product names.

It will be appreciated by those skilled in the art that the present disclosure as described above may be implemented into other specific forms without departing from the technical spirit thereof or essential characteristics. Thus, it is to be appreciated that embodiments described above are intended to be illustrative in every sense, and not restrictive. The scope of the present invention is represented by the claims to be described below rather than the detailed description, and it is to be interpreted that the meaning and scope of the claims and all the changes or modified forms derived from the equivalents thereof come within the scope of the present invention.

FIG. 10 is a flowchart of a smart commerce method using a smart reader according to an exemplary embodiment of the present disclosure.

The smart commerce device 141 maps a payment unit to the smart reader 120 (S1002). Here, the payment unit may be any one of a credit card, a mobile card, an application card, a smart card, and a prepaid card. The payment unit may include a payment unit which is identifiable by the user information and is available to purchase the product and is not limited to a specific payment unit. Before step S1002, the payment service device 400 may issue any one of the credit card, the mobile card, the application card, the smart card, and the prepaid card as a payment unit for purchasing a product using the smart reader 120.

Further, the smart reader 120 recognizes the product code for the product to obtain the product code (S1004). Here, the smart reader 120 may recognize the product code for a virtual product which is displayed on the product display stand 110 or a virtual product display stand.

The, the smart reader 120 converts the obtained product code into product information (S1006).

Next, the smart reader 120 records the converted product information in the NFC tag (S1008).

In the meantime, the shopping association device 10 obtains the recorded product information through the NFC communication with the smart reader 120 (S1010). Here, the shopping association device 10 may include at least one of the user terminal 190, the reader management device 140, the product sales terminal 160, the smart checkout device 150, and the shopping cart 170.

Further, the shopping association device 10 checks the product order details for the obtained product code information (S1012). The product order details may include a product name of the product, a product price, brief description of the product, and product evaluation.

Next, the shopping association device 10 requests the product payment and product delivery (S1014).

Further, the commerce service device 300 identifies the smart reader 120 before requesting the product payment and checks a payment unit mapped to the identified smart reader 120 in step S1002 (S1016).

Next, the commerce service device 300 requests the payment service device 400 to make a payment for the product by the mapped payment unit (S1018).

The payment service device 400 makes a payment for the product using the mapped payment unit in accordance with the payment request of the commerce service device 300 (S1020).

In the meantime, a commerce method using the above-described smart reader will be described.

To this end, according to the exemplary embodiment of the present disclosure, a commerce service device 300 and a payment service device 400 may be further provided.

The commerce service device 300 may be implemented by the shopping service providing device (140 in FIG. 1) and map the payment unit for purchasing the product to the smart reader device 120. Further, the commerce service device 300 maps the commerce site 101 for purchasing the product to the smart reader device 120. The commerce service device 300 searches the product details for the product information and the product commerce information through the mapped commerce site 101. For example, when the mapped commerce site is a price comparison site, the commerce service device 300 searches for the product details for the product information obtained from the price comparison site and the price comparison information for each product corresponding to the product commerce information. As another example, when the commerce site is a shopping mall site, the commerce service device 300 searches for the product details for the product information obtained from the product purchase site and the additional product information for each product corresponding to the product commerce information. Thereafter, the commerce service device 300 checks the product details for the product information and requests the payment service device 190 to make a payment using the mapped payment unit. Further, when there is a request for product purchase by the user from the commerce association device 10, the commerce service device 300 may request to make a payment for the product through the mapped commerce site 101.

FIG. 11 is a flowchart of a smart commerce method using a smart reader according to an exemplary embodiment of the present disclosure.

The smart commerce device 141 maps the price comparison site to the smart reader 120 (S1102). Here, the price comparison site provides the price comparison information of the prices of the product according priorities (for example, popularities, prices, releasing date, a rating order, or a purchase rank) posted on an offline or online shopping mall site. The price comparison site and the smart reader 120 are previously mapped to each other before purchasing the product using the smart reader 120. By doing this, the user may purchase a product with a discounted price through the mapped price comparison site or purchase a product through an additional service such as a promotion.

Further, the smart reader 120 recognizes the product code for the product to obtain the product code (S1104). Here, the smart reader 120 may recognize the product code for a virtual product which is displayed on the product display stand 110 or a virtual product display stand.

The, the smart reader 120 converts the obtained product code into product information (S1106).

Next, the smart reader 120 records the converted product information in the NFC tag (S1108).

In the meantime, the shopping association device 10 obtains the recorded product information through the NFC communication with the smart reader 120 (S1110). Here, the shopping association device 10 may include at least one of the user terminal 190, the reader management device 140, the product sales terminal 160, the smart checkout device 150, and the shopping cart 170.

The commerce service device 300 obtains the product order details for the product obtained in the shopping association device 10 from the shopping association device 10 (S1112).

The commerce service device 300 searches for the product order details and price comparison information corresponding to product commerce information through the price comparison site (S1114). The price comparison information refers to information obtained by comparing prices of a product which is associated with the online or offline shopping mall site related to the product. The price comparison information may be information obtained by classifying the prices of the product for every online shopping purchase site to compare the prices. Here, the commerce service device 300 checks whether there is additional product information which is set by a user through the smart reader 120 to automatically purchase the product in accordance with a product purchasing cycle.

The commerce service device 300 may add additional product information to the product information according to the product purchase cycle. In this case, the commerce service device 300 may search for the product order details and the product commerce information for the product information to which the additional product information is added through the mapped commerce site.

When the commerce service device 300 transmits the searched product order details and price comparison information corresponding to the product commerce information to the shopping association device 10, the shopping association device 10 displays the searched product order details and price comparison information corresponding to the product commerce information to the user (S1116).

The commerce service device 300 accepts selection of product purchase for the product order details desired by the user, among the displayed price comparison information (S1118).

Next, the shopping association device 10 requests the product payment and product delivery for the product order details which is selected to be purchased by the user (S1120).

Further, the commerce service device 300 identifies the smart reader 120 before requesting the product payment and checks the price comparison site mapped to the identified smart reader 120 in step S1102 and also checks the product order details which are selected to be purchased by the user (S1122).

Next, the commerce service device 300 requests the payment service device 400 to make a payment for the product through the mapped price comparison site (S1124). Here, the commerce service device 300 may request another shopping site which is linked to price comparison information of the price comparison site to make a payment for the product.

The payment service device 400 makes a payment for the product through the mapped price comparison site in accordance with the payment request of the commerce service device 300 (S1126).

FIG. 12 is a flowchart of a smart commerce method using a smart reader according to an exemplary embodiment of the present disclosure.

The smart commerce device 141 maps the shopping mall site to the smart reader 120 (S1202). Here, the shopping site provides the prices of the product in accordance with the priorities posted on the offline or online shopping mall site. The shopping mall site and the smart reader 120 are previously mapped to each other before purchasing the product using the smart reader 120. By doing this, the user may purchase a product with a discounted price through the mapped shopping mall site or purchase a product through an additional service such as a promotion.

Further, the smart reader 120 recognizes the product code for the product to obtain the product code (S1204). Here, the smart reader 120 may recognize the product code for a virtual product which is displayed on the product display stand 110 or a virtual product display stand.

Then, the smart reader 120 converts the obtained product code into product information (S1206).

Next, the smart reader 120 records the converted product information in the NFC tag (S1208).

In the meantime, the shopping association device 10 obtains the recorded product information through the NFC communication with the smart reader 120 (S1210). Here, the shopping association device 10 may include at least one of the user terminal 190, the reader management device 140, the product sales terminal 160, the smart checkout device 150, and the shopping cart 170.

The commerce service device 300 obtains the product order details for the product obtained in the shopping association device 10 from the shopping association device 10 (S1212).

The commerce service device 300 searches for the product order details and additional price information corresponding to product commerce information through the shopping mall site (S1214). Here, the additional product information may refer to promotion information such as event information, discount coupon, free coupon, or video or access information which allows access to a medium in which promotion information is stored.

When the commerce service device 300 transmits the searched product order details and additional price information corresponding to the product commerce information to the shopping association device 10, the shopping association device 10 displays the searched product order details and additional price information corresponding to the product commerce information to the user (S1216).

The commerce service device 300 accepts selection of product purchase for the product order details desired by the user, among the displayed additional product information (S1218).

Next, the shopping association device 10 requests the product payment and product delivery for the product order details which is selected to be purchased by the user (S1220).

Further, the commerce service device 300 identifies the smart reader 120 before requesting the product payment and checks the shopping mall site mapped to the identified smart reader 120 in step S1102 and also checks the product order details which is selected to be purchased by the user (S1222).

Next, the commerce service device 300 requests the payment service device 400 to make a payment for the product through the mapped shopping mall site (S1224). Here, the commerce service device 300 may request another shopping site which is linked to the additional product information of the shopping mall site to make a payment for the product.

The payment service device 400 makes a payment for the product through the mapped shopping mall site in accordance with the payment request of the commerce service device 300 (S1226).

In the meantime, exemplary embodiments of the present invention have been disclosed in the specification and the drawings and specific terms are used therein. However, even though specific terms are used, this is used for a general meaning to easily explain the technical content of the present invention and help to understand the invention, but does not limit the scope of the present invention. It is obvious to those skilled in the art that modifications based on the technical spirit of the present invention, other than the disclosed exemplary embodiment are allowed.

### INDUSTRIAL APPLICABILITY

The present invention is applicable to a shopping service related technical field which enables self-shopping through NFC communication, such as marts or departments.

1. A shopping service system using a smart reader, comprising:
a smart reader which recognizes a product code for a product to obtain product code information and records the obtained product code information in an NFC tag;
a shopping association device which obtains the product code information recorded in the NFC tag through NFC communication with the smart reader, checks product order details for the obtained product code information, and performs any one of inquiry, modification of order details, product payment, and product delivery for the product order details; and
a shopping service providing device which manages product code information for the product, performs product payment requested from the shopping association device, and manages delivery of the paid product.

2. The shopping service system according to claim 1, further comprising:
a virtual product display stand on which a product code for a virtual product is displayed,
wherein the smart reader recognizes a product code displayed on the virtual product display stand.

3. The shopping service system according to claim 1, wherein the product association device includes:
a reader rental device which manages rental and return of the smart reader through membership information identification of the user.

4. The shopping service system according to claim 3, wherein the reader rental device receives the product code information from the shopping service providing device to update the smart reader and includes a charger to charge a smart reader which is being stored.

5. The shopping service system according to claim 1, wherein the shopping association device includes:
an NFC dongle which includes an NFC reader and obtains the recorded product information through NFC communication with the smart reader; and
a smart checkout device which checks product order details for the product code information obtained through the NFC dongle and a product payment amount for the product order details to display the product order details and the product payment amount to the user, and requests the shopping service providing device to make a payment for the product corresponding to the displayed product payment amount through a payment unit of the user and deliver the product.

6. The shopping service system according to claim 1, wherein the shopping association device includes:
an NFC dongle which includes an NFC reader and obtains the recorded product information through NFC communication with the smart reader; and
an order inquiry device which inquires and checks the product order details for the product code information obtained through the NFC dongle and modifies the product for the product order details.

7. The shopping service system according to claim 1, wherein the shopping association device includes:
an NFC dongle which includes an NFC reader and obtains the recorded product information through NFC communication with the smart reader; and
a product sales terminal which checks the product order details for the product information obtained through the NFC dongle and a product payment amount for the product order details to display the product order details and the product payment amount to a store staff and requests the shopping service providing device to make a payment for a product corresponding to the displayed product payment amount through the payment unit of the user and deliver the product.

8. A shopping service method using a smart reader, comprising:
obtaining product code information by recognizing a product code for a product, by a smart reader;
recording the obtained product code information in an NFC code, by the smart reader;
obtaining the product code information recorded in the NFC tag through NFC communication with the smart reader, by a shopping association device;
checking product order details for the obtained product code information and performing any one of inquiry, modification of order details, product payment, and product delivery for the product order details, by the shopping association device;
performing product payment requested from the shopping association device, by a shopping service providing device; and
managing delivery of the paid product, by the shopping service providing device.

9. The shopping service method according to claim 8, wherein in the obtaining of product code information, the smart reader recognizes a product code for a virtual product displayed on a virtual product display stand.

10. The shopping service method according to claim 9, further comprising:
in the performing of any one of inquiry, modification of order details, product payment, and product delivery for the product order details, when the product association device is a reader rental device,
managing rental and return of the smart reader by identifying membership information of the user, by the reader rental device.

11. The shopping service method according to claim 10, further comprising:
when the product association device is a reader rental device,
receiving the product code information from the shopping service providing device by the reader rental device to update the smart reader and charging a smart reader which is being stored by being equipped with a charger.

12. The shopping service method according to claim 8, further comprising:
in the performing of any one of inquiry, modification of order details, product payment, and product delivery for the product order details, when the product association device is a smart checkout device,
obtaining the product code information recorded in the NFC tag through NFC communication with the smart reader, by the smart checkout device;
checking product order details for the product code information and a product payment amount for the product order details, by the smart checkout device, to display the product order details and the product payment amount to the user; and
requesting the shopping service providing device to make a payment for the product corresponding to the displayed product payment amount through a payment unit of the user and deliver the product, by the smart checkout device.

13. The shopping service method according to claim 8, further comprising:
in the performing of any one of inquiry, modification of order details, product payment, and product delivery for the product order details, when the product association device is an order inquiry device,
inquiring and checking the product order details for the product code information obtained through NFC communication with the smart reader and modifying the product for the product order details, by the order inquiry device.

14. The shopping service method according to claim 8, further comprising:
in the performing of any one of inquiry, modification of order details, product payment, and product delivery for the product order details, when the product association device is a product sales terminal,
obtaining the product code information recorded in the NFC tag through NFC communication with the smart reader, by the product sales terminal;
checking product order details for the product code information and a product payment amount for the product order details, by the product sales terminal, to display the product order details and the product payment amount to a store staff; and
requesting the shopping service providing device to make a payment for the product corresponding to the displayed product payment amount through a payment unit of the user and deliver the product, by the product sales terminal.

15. (canceled)

16. (canceled)

17. (canceled)

18. A smart commerce method using a smart reader, comprising:
mapping a commerce site for product purchase to a smart reader equipped with an NFC tag, by a commerce service device;
obtaining a product code by recognizing the product code for a product and recording the product information in the NFC tag by converting the obtained product code into product information, by the smart reader;
obtaining the recorded product information through NFC communication with the smart reader, by a shopping association device;
requesting product payment through the mapped commerce site by the commerce service device, when there is product purchase request of a user from the shopping association device; and
making a payment for a product requested through the mapped commerce site, by the payment service device.

19. The smart commerce method according to claim 18, wherein in the recording of the product information in the NFC tag, the smart reader recognizes a product code for a virtual product displayed on a virtual product display stand.

20. The smart commerce method according to claim 18, further comprising:
searching for product details for the obtained product information and product commerce information through the mapped commerce site, by the commerce service device; and
displaying the searched product details and product commerce information to the user, by the shopping association device.

21. The smart commerce method according to claim 20, wherein:
in the searching for the product details and the product commerce information, when the mapped commerce site is a price comparison site,
the commerce service device searches for product details for the obtained product information and price comparison information for each product corresponding to the product commerce information in the price comparison site.

22. The smart commerce method according to claim 20, wherein in the searching for the product details and the product commerce information, when the mapped commerce site is a shopping mall site, the commerce service device searches for product details for the obtained product information and additional product information for each product corresponding to the product commerce information in the product purchase site.

23. The smart commerce method according to claim 20, further comprising:
when there is additional product information which is set to automatically purchase the product in accordance with a product purchasing cycle, adding additional product information to the obtained product information in accordance with the product purchasing cycle, by the commerce service device,
wherein in the searching for the product details for the obtained product information and the product commerce information, product details for product information to which the additional product information is added and the product commerce information are searched through the mapped commerce site.
